(19) United States
(12) Patent Application Publication
(10) Pub. No.: US 2019/0120293 A1
(43) Pub. Date: Apr. 25, 2019

(54) POROUS AEROSTATIC BEARING

(71) Applicant: Industrial Technology Research Institute, HSIN-CHU (TW)

(72) Inventors: YU-CHIEH KUO, Taipei City (TW); SHAO-YU HSU, Hsinchu City (TW); CHIA-MENG CHEN, Hsinchu City (TW); YU-KUN LIN, Taichung City (TW); CHUN-HSIEN SU, Hsinchu City (TW)

(21) Appl. No.: 15/833,153

(22) Filed: Dec. 6, 2017

(30) Foreign Application Priority Data
Oct. 20, 2017 (TW) 106136222

(51) Int. Cl. F16C 32/06; F16C 23/10; F16C 23/02

(52) U.S. Cl. CPC F16C 32/0618; F16C 23/10; F16C 43/02; F16C 2202/10; F16C 23/02

(57) ABSTRACT

A porous aerostatic bearing includes a bearing seat and a plurality of porous plunger assemblies. The bearing seat is furnished with a plurality of accommodating holes. By locking the porous plunger assemblies individually into the corresponding accommodating holes, the porous aerostatic bearing with adjustable stiffness can thus be formed, difficulty in maintenance thereof can be lowered, and the entire service expense therefor can be substantially reduced.

### CROSS REFERENCE TO RELATED APPLICATION

The present application is based on and claims priority from Taiwan (International) Application Serial Number 106136222, filed on Oct. 20, 2017, the disclosure of which is hereby incorporated by reference herein in its entirety.

### TECHNICAL FIELD

The present disclosure relates in general to an aerostatic bearing, and more particularly to a porous aerostatic bearing whose stiffness can be adjusted.

### BACKGROUND

In the art, an air bearing is one type of sliding bearings that utilizes an air as its lubricant. The air bearing is featured in having a low friction coefficient and a low friction torque. Usage of the air bearing would barely affect precision of application, and thus the air bearing is highly suitable for high-precision and high-speed applications. In addition, the air bearing is also characterized on a long lifespan, easy maintenance, temperature resistance and so on, from which the application range of air bearing becomes wider and wider.

Generally speaking, the air bearings can be classified into pneumatic bearings and aerostatic bearings. An air membrane would be induced by rotating the pneumatic bearing at a high speed, and such a pressurized air membrane would be then able to provide sustenance for further applications. On the other hand, the aerostatic bearing utilizes an air-supply system to provide a pressurized air to a throttle for further injecting the pressurized air therefrom into a bearing gap, such that air sustenance thereof can be formed.

However, since lower viscosity of the air would result in less sustenance and lower stiffness to affect operations of the aerostatic bearing, thus the application range of aerostatic bearing is substantially limited. Hence, an issue of improving the aerostatic bearing or further providing a “porous aerostatic bearing” that can effectively avoid the aforesaid shortcomings of the aerostatic bearing is definitely urgent to be solved.

### SUMMARY

An object of the present disclosure is to provide a porous aerostatic bearing, whose porous plunger assemblies and bearing seat can be separately produced, such that the stiffness of the porous aerostatic bearing can be adjusted according to testing results. In addition, the porous plunger assemblies can be inspected individually, so that testing thereupon can be carried out easily. Further, follow-up maintenance and service would be much flexible, difficulty in maintenance can be lowered, and the entire service expense can be substantially reduced.

In this disclosure, the porous aerostatic bearing includes a bearing seat and a plurality of porous plunger assemblies. The bearing seat is furnished with a plurality of accommodation holes. The porous plunger assemblies are individually locked into the respective accommodation holes, so that the porous aerostatic bearing can be formed.

In one embodiment of this disclosure, each of the porous plunger assemblies includes a porous structure and a plunger. The plunger includes thereinside a receiving section for accommodating the porous structure.

In one embodiment of this disclosure, each of the porous plunger assemblies includes an air channel communicated spatially with the receiving section.

In one embodiment of this disclosure, the porous structure includes a ceramic material.

In one embodiment of this disclosure, the porous structure is adhered into the receiving section.

In one embodiment of this disclosure, the plunger includes an external thread, and each of the plurality of accommodation holes is furnished with an internal thread for engaging the external thread so as to position the porous plunger assembly at the bearing seat.

As stated above, in this disclosure, a different porous aerostatic bearing can be obtained by locking the porous plunger assembly to a different position in the respective accommodation hole at the bearing seat. In addition, since the porous plunger assemblies and the bearing seat can be separately produced, the air gap of bearing can be adjusted by varying the position of the porous plunger assembly inside the accommodation hole, and thereby the stiffness of the porous aerostatic bearing can be adjusted to reduce possible air hammers.

Further, since the porous plunger assembly and the bearing seat are different elements, and if the porous aerostatic bearing needs maintenance or additional service, then each of the porous plunger assemblies can be screwed out of the corresponding accommodation hole for individual inspection. In addition, according to damages of individual porous plunger assembly, the number of the porous plunger assemblies to be replaced can be determined according to the inspection result. Namely, in this disclosure, no matter what the number of the porous plunger assemblies needs to be replaced, the bearing seat can be always maintained. Thereupon, difficulty in maintenance can be lowered, and the entire service expense can be substantially reduced.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings, which are given by way of illustration only, and thus are not limitative of the present disclosure and wherein:

FIG. 1 is a schematic cross-sectional view of the preferred porous aerostatic bearing in accordance with the present disclosure;

FIG. 2 is a schematic perspective view of the porous plunger assembly of FIG. 1;

FIG. 3 is a schematic cross-sectional view of an embodiment of locking the porous plunger assembly into the bearing seat (partly shown) of FIG. 1;

FIG. 4 is a schematic cross-sectional view of the preferred porous aerostatic spindle in accordance with the present disclosure; and

FIG. 5 to FIG. 7 demonstrate schematically different positions of the accommodation hole and the spindle with respect to different styles of the porous plunger assembly locked in the bearing seat.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

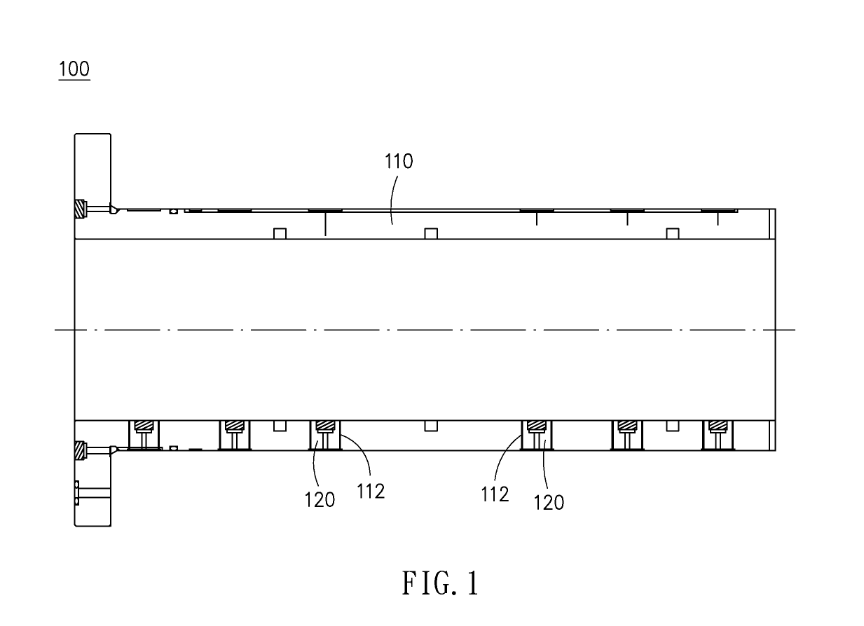

Referring now to FIG. 1, a schematic cross-sectional view of the preferred porous aerostatic bearing in accordance with the present disclosure is shown. In this embodiment, the porous aerostatic bearing 100 includes a bearing seat 110 and a plurality of porous plunger assemblies 120. The bearing seat 110 is furnished with a plurality of accommodation holes 112 to lock individually the porous plunger assemblies 120 so as to form a corresponding porous aerostatic bearing 100.

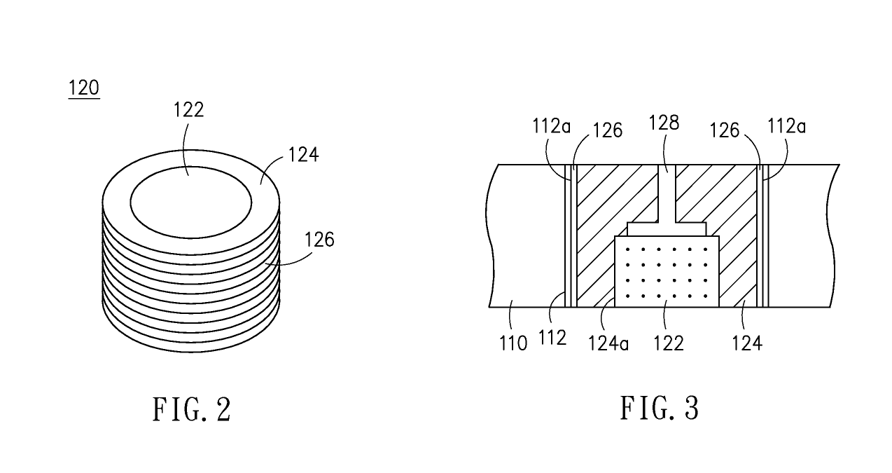

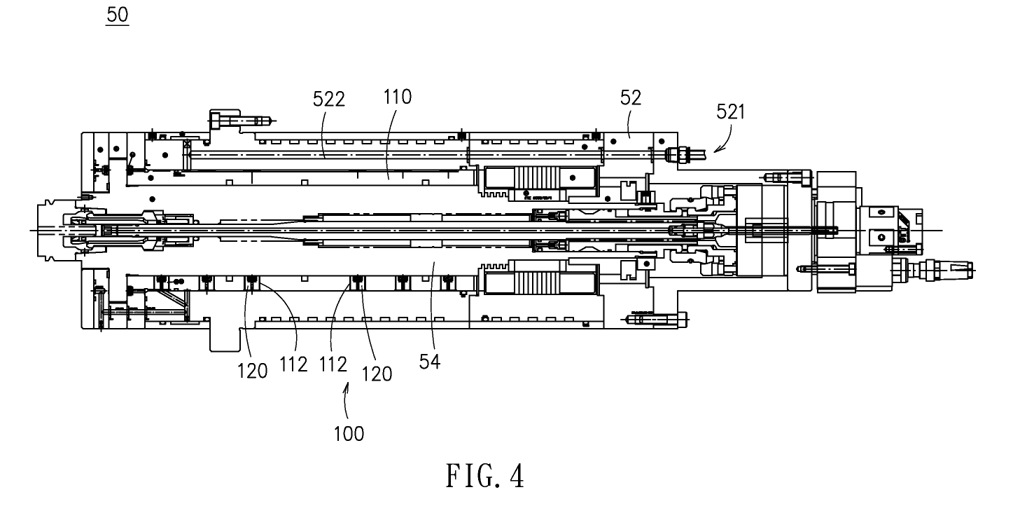

In details, refer now to FIG. 2 and FIG. 3; where FIG. 2 is a schematic perspective view of the porous plunger assembly of FIG. 1, and FIG. 3 is a schematic cross-sectional view of an embodiment of locking the porous plunger assembly into the bearing seat (partly shown) of FIG. 1. In this embodiment, the porous plunger assembly 120, shaped as a cylinder, includes a porous structure 122, a plunger 124, an external thread 126 and an air channel 128.

The plunger 124, made of a metallic material preferably, includes a receiving section 124a connected spatially with the air channel 128. The porous structure 122, located inside the receiving section 124a, is formed by sintering metallic or non-metallic particles. In addition, the porous structure 122 is adhered inside to the receiving section 124a. An internal thread 112a is provided to an accommodation hole 112 of the bearing seat 110 for receiving the porous plunger assembly 120. By screwing the external thread 126 to engage the internal thread 112a, the corresponding porous plunger assembly 120 can be thus positioned in the bearing seat 110. Thereupon, the external air can reach the porous structure 122 by passing through the corresponding air channel 128. In this disclosure, porosity of the porous structure 122 would contribute a large number of micro air channels for the introduced air to flow therethrough, and thus uniformity of air flow after passing through the porous structure 122 can be obtained. In this embodiment, the porous structure 122 can include, but not limited to, a ceramic material.

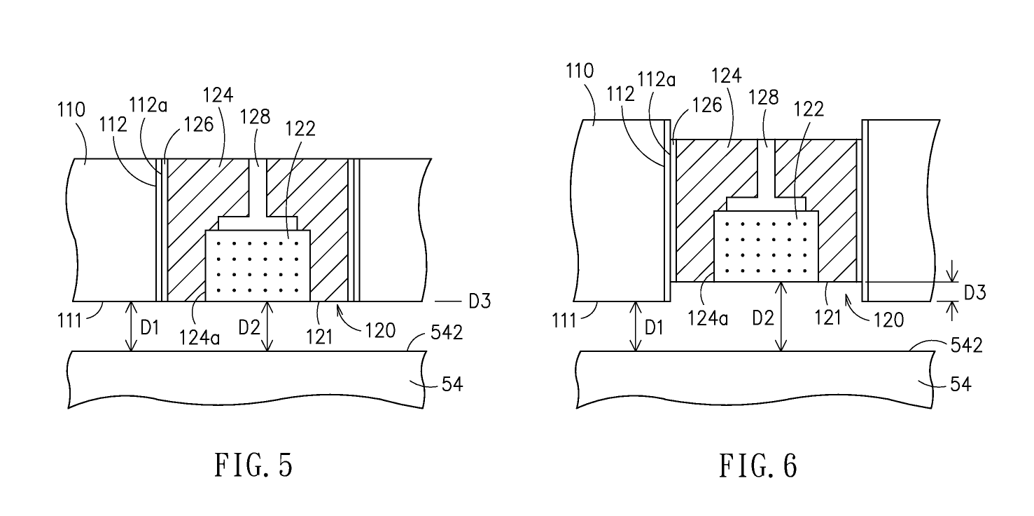

Referring now to FIG. 4, a schematic cross-sectional view of the preferred porous aerostatic spindle in accordance with the present disclosure is shown. In this embodiment, the porous aerostatic spindle 50 includes a spindle casing 52, a porous aerostatic bearing 100 and a spindle 54.

The porous aerostatic bearing 100 is located inside the spindle casing 52. The spindle casing 52 includes an air-supply channel 521 and an internal air channel 522. The air-supply channel 521 is communicated spatially with the internal air channel 522, and the internal air channel 522 is further communicated spatially with the air channel 128 of the porous plunger assembly 120. The spindle 54 is disposed in the bearing seat 110.

In one embodiment, by referring also to FIG. 3, an air-supply system (not shown in the figure) is applied to provide the air to the air-supply channel 521. The air in the air-supply channel 521 is further flowed to the internal air channel 522, such that the air is now flowing inside the spindle casing 52. Then, through the internal air channel 522, the air is distributed to the air channels 128 of the corresponding porous plunger assemblies 120. In each air channel 128, the air is transmitted to the porous structure 122 inside the receiving section 124a. Due to the porosity of the porous structure 122, the air after passing the porous structure 122 would be uniformly flowed to the spindle 54. Namely, the air is inputted to the spindle 54 by passing through the porous structures 122 of the corresponding porous plunger assemblies 120 arranged annularly around the spindle 54. With the uniform input of the air and the driving of a motor, the spindle 54 can be floated to undergo rotating motion.

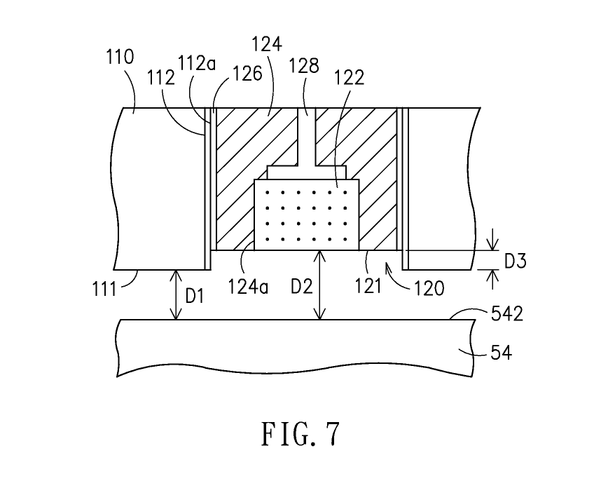

FIG. 5 to FIG. 7 demonstrate schematically different positions of the accommodation hole and the spindle with respect to different styles of the porous plunger assembly locked in the bearing seat. As shown, a first air gap D1 exists between the inner surface 111 of the bearing seat 110 and the outer surface 542 of the spindle 54, a second air gap D2 exists between the inner surface 121 of the porous plunger assembly 120 and the outer surface 542 of the spindle 54, and an air gap of bearing (bearing gap) D3 is defined as the difference of the second air gap D2 and the first air gap D1.

In this embodiment, the porous plunger assemblies 120 are locked into different accommodation holes 112 with the internal threads 112a at the bearing seat 110, such that the air gap of bearing D3 can be adjusted by varying the locking positions of the porous plunger assemblies 120 in the corresponding accommodation holes 112. As shown in FIG. 5, the inner surface 121 of the porous plunger assembly 120 is flush with the inner surface 111 of the bearing seat 110. In this instance, the second air gap D2, equal to the first air gap D1, is set to be 10 μm, and thus the air gap of bearing D3 is 0 μm. As shown in FIG. 6, the porous plunger assembly 120 is locked to a position where the inner surface 121 of the porous plunger assembly 120 inside the accommodation hole 112 is not flush with the inner surface 111 of the bearing seat 110. In this instance, the second air gap D2 is larger than the first air gap D1. If the first air gap D is 10 μm and the second air gap D2 is 15 μm, then the air gap of bearing D3 would be 5 μm. As shown in FIG. 7, the second air gap D2 is larger than the first air gap D1. However, by comparing to FIG. 6, the porous plunger assembly 120 of FIG. 7 is locked to a farther position from the spindle 54. If the first air gap D1 is 10 μm and the second air gap D2 is 20 μm, then the air gap of bearing D3 would be 10 μm.

A reference table for the air gap of bearing versus the mean air-gap pressure is listed in Table 1 as follows.

TABLE 1

| Air gap of bearing (μm) | Mean air-gap pressure (kPa) |
|---|---|
| 0 μm | 277.33 kPa |
| 5 μm | 274.26 kPa |
| 10 μm | 269.32 kPa |

From Table 1, it is noted that, as the air gap of bearing decreases, the corresponding mean air-gap pressure is increased, and thus the stiffness of the bearing is increased as well. Namely, the stiffness of the porous aerostatic bearing 100 in this disclosure can be adjusted according to the design setups.

In summary of this disclosure, a different porous aerostatic bearing can be obtained by locking the porous plunger assembly to a different position in the respective accommodation hole at the bearing seat. In addition, since the porous plunger assembly and the bearing seat can be separately produced, thus the air gap of bearing can be adjusted by varying the position of the porous plunger assembly inside the accommodation hole, and thereby the stiffness of the porous aerostatic bearing can be adjusted to reduce possible air hammers.

In addition, since the porous plunger assembly and the bearing seat are different elements, and if the porous aerostatic bearing needs maintenance or additional service, then each of the porous plunger assemblies can be screwed out of the corresponding accommodation hole for individual inspection. Further, according to damages of individual porous plunger assembly, the number of the porous plunger assemblies can be replaced according to the inspection result. Namely, in this disclosure, no matter what the number of the porous plunger assemblies needs to be replaced, the bearing seat can be always maintained. Thereupon, difficulty in maintenance can be lowered, and the entire service expense can be substantially reduced.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A porous aerostatic bearing, comprising:
a bearing seat, furnished with a plurality of accommodation holes; and
a plurality of porous plunger assemblies, locked individually to the corresponding accommodation holes.

2. The porous aerostatic bearing of claim 1, wherein each of the plurality of porous plunger assemblies includes a porous structure and a plunger, and the plunger further includes a receiving section thereinside to accommodate the porous structure.

3. The porous aerostatic bearing of claim 2, wherein each of the plurality of porous plunger assemblies includes an air channel communicated spatially with the receiving section.

4. The porous aerostatic bearing of claim 2, wherein the porous structure includes a ceramic material.

5. The porous aerostatic bearing of claim 2, wherein the porous structure is adhered into the receiving section.

6. The porous aerostatic bearing of claim 2, wherein the plunger includes an external thread, and each of the plurality of accommodation holes is furnished with an internal thread for engaging the external thread so as to position the porous plunger assembly at the bearing seat.
